(19) United States
(12) Patent Application Publication
(10) Pub. No.: US 2012/0081060 A1
(43) Pub. Date: Apr. 5, 2012

(54) CONTROL APPARATUS FOR DRIVING APPARATUS

(75) Inventors: Masami ISHIKAWA, Handa (JP); Tomohiko ITO, Nishio (JP)

(73) Assignee: AISIN AW CO., LTD., Anjo-shi (JP)

(21) Appl. No.: 13/210,749

(22) Filed: Aug. 16, 2011

(30) Foreign Application Priority Data
Sep. 30, 2010 (JP) 2010-221275

(51) Int. Cl. H02P 25/08

(52) U.S. Cl. 318/491

(57) ABSTRACT

A control apparatus that controls a driving apparatus configured with a stator. A variable magnetic flux type rotating electrical machine has a first and second rotor, circumferential direction relative positions of which can be adjusted. A relative position adjustment mechanism adjusts the relative positions of the two rotors. A control command determination unit that determines, on the basis of a required torque and a rotation speed, an inter-rotor phase command indicating the relative positions for minimizing a system loss including at least an electrical loss, which includes a copper loss and an iron loss of the rotating electrical machine, and a mechanical loss of the relative position adjustment mechanism. A current command drives the rotating electrical machine. A control unit controls the rotating electrical machine on the basis of the current command and controls the relative position adjustment mechanism on the basis of the inter-rotor phase command.

### INCORPORATION BY REFERENCE

The disclosure of Japanese Patent Application No. 2010-221275 filed on Sep. 30, 2010 including the specification, drawings and abstract is incorporated herein by reference in its entirety.

### BACKGROUND OF THE INVENTION

The present invention relates to a control apparatus for a driving apparatus, including a variable magnetic flux type rotating electrical machine that includes a plurality of rotors, circumferential direction relative positions of which can be adjusted, and is capable of modifying field flux, and a mechanism that adjusts the relative positions.

### DESCRIPTION OF THE RELATED ART

Interior permanent magnet synchronous motors (IPMSMs), which include a rotor having a permanent magnet buried in its interior, are widely used. In an IPMSM, the permanent magnet is typically fixed to a rotor core, and therefore magnetic flux generated from the rotor is constant. As a rotation speed of the rotor increases, an induced voltage generated in a stator coil rises, and when the induced voltage exceeds a drive voltage, control may become impossible. To avoid this, field weakening control is performed at or above a certain rotation speed so that a magnetic field from the rotor is substantially weakened. When field weakening control is performed, however, a current flowing to the stator coil increases relative to a torque output from the synchronous motor. As a result, copper loss increases, leading to a reduction in efficiency. Further, if magnetic flux that reaches a stator from the permanent magnet remains constant, iron loss occurring in a stator core increases in a high rotor rotation speed region, leading to a reduction in efficiency.

Hence, a variable magnetic flux type rotating electrical machine for varying magnetic flux that reaches a stator from a permanent magnet provided in a rotor in accordance with the rotation speed of the rotor has been proposed. Japanese Patent Application Publication JP2002-58223A discloses a rotating electrical machine including a diameter outer side rotor (100) and a diameter inner side rotor (200) accommodated on a diametric inner side of the diameter outer side rotor (reference numerals are those used in JP2002-58223A; likewise hereafter within the description of the related art). The diameter outer side rotor (100), which rotates while facing an inner peripheral surface of a stator core (301), includes a permanent magnet (103) that generates field flux. The diameter inner side rotor (200) is constituted by a yoke or a magnet rotor that has an outer peripheral surface facing an inner peripheral surface of the diameter outer side rotor and is disposed to be free to rotate. A circumferential direction relative phase of the two rotors can be modified by a planetary reduction gear mechanism accommodated in a gear housing (4) (JP2002-58223A: paragraphs 27 to 37, FIGS. 1 to 3, Abstract, etc.). Further, Japanese Patent Application Publication JP2004-72978A discloses a constitution in which a permanent magnet is provided in both the diameter inner side rotor and the diameter outer side rotor, and in which field flux reaching the stator is modified by adjusting relative positions of the two rotors (FIGS. 1 and 2, etc.).

It is well known that loss such as copper loss, iron loss, and inverter loss affects the efficiency of a rotating electrical machine, and it is therefore desirable to implement control for minimizing this loss. In a variable magnetic flux type rotating electrical machine such as those described above, a field weakening current can be reduced by modifying the field flux mechanically. As a result, copper loss, inverter loss, and iron loss can be suppressed, enabling an improvement in the efficiency of the rotating electrical machine. However, when a mechanism that mechanically adjusts the relative positions of two rotors, such as the planetary reduction gear mechanism of JP2002-58223A, is provided, gear mechanism-generated loss also occurs, and this loss in the gear mechanism does not remain constant with respect to the relative positions of the rotors. Therefore, when the rotating electrical machine is controlled simply by selecting relative positions at which copper loss, iron loss, inverter loss, and so on are minimized, it may be impossible to realize optimization control with which the loss of the entire apparatus, including the gear mechanism, is minimized.

### SUMMARY OF THE INVENTION

In consideration of the background described above, an object of the present invention is to provide a technique for performing optimization control on a driving apparatus including a rotating electrical machine that includes a plurality of rotors, circumferential direction relative positions of which can be adjusted, and is capable of modifying field flux.

A control apparatus for a driving apparatus according to a first aspect of the present invention controls a driving apparatus that includes a stator, a variable magnetic flux type rotating electrical machine having a first rotor and a second rotor, circumferential direction relative positions of which can be adjusted, and a relative position adjustment mechanism that adjusts the relative positions of the two rotors, wherein the control apparatus includes: a control command determination unit that determines, on the basis of a required torque and a rotation speed, an inter-rotor phase command indicating the relative positions for minimizing a system loss including at least an electrical loss, which includes a copper loss and an iron loss of the rotating electrical machine, and a mechanical loss of the relative position adjustment mechanism, and a current command for driving the rotating electrical machine; and a control unit that controls the rotating electrical machine on the basis of the current command and controls the relative position adjustment mechanism on the basis of the inter-rotor phase command.

The electrical loss and the mechanical loss in the relative position adjustment mechanism differ according to the relative positions of the first rotor and the second rotor. The optimum relative positions may be determined on the basis of a relationship between the system loss combining the electrical loss and the mechanical loss and the relative positions of the two rotors. According to the first aspect, the inter-rotor phase command indicating the relative positions of the two rotors for minimizing the system loss and the current command for driving the rotating electrical machine are determined on the basis of the required torque and the rotation speed of the driving apparatus. The rotating electrical machine and the relative position adjustment mechanism are therefore controlled on the basis of a control command determined such that the system loss is minimized within a range where the required torque can be output. As a result, optimization control can be implemented such that the system loss of the driving apparatus is minimized.

According to a second aspect of the present invention, when the relative position adjustment mechanism includes a gear mechanism that drive-couples the first rotor and the second rotor, the mechanical loss may be determined as follows. The mechanical loss of the relative position adjustment mechanism is determined on the basis of a sum of an absolute value of a product of a first rotor torque generated in the first rotor in accordance with the relative positions of the two rotors and a loss rate of the gear mechanism connected to the first rotor and an absolute value of a product of a second rotor torque generated in the second rotor in accordance with the relative positions of the two rotors and a gear loss rate of the gear mechanism connected to the second rotor. A torque oriented in an identical direction to an output torque of the rotating electrical machine and a torque oriented in an opposite direction may act on the first rotor and the second rotor, the circumferential direction relative positions of which can be adjusted, depending on an attraction/repulsion force generated between the rotors in accordance with variation in a magnetic circuit. When the torque acting on one of the rotors is the opposite direction torque, the sum of the torque of the two rotors is greater than a total torque of the entire rotor (the output torque of the rotating electrical machine). In other words, the sum of the absolute values of the torque of the two rotors is greater than an absolute value of the total torque. Incidentally, when the two rotors both include gear mechanisms, gear loss occurs in the respective gear mechanisms. When the sum of the absolute values of the torque of the two rotors increases, a sum total of the gear loss increases correspondingly. In other words, at a constant total torque, the total gear loss increases as the absolute value of the opposite direction torque corresponding to the attraction/repulsion force between the rotors increases, leading to an increase in loss torque and a reduction in efficiency. Gear loss occurs in the gear mechanisms connected to the respective rotors, and therefore, when the gear loss rate is multiplied by the total torque, a smaller value than an actual mechanical loss is obtained. Therefore, by multiplying the gear loss rate by the absolute values of the torque of the respective rotors, as described above, the mechanical loss is calculated accurately.

When the gear mechanisms that drive-couples the first rotor and the second rotor are constituted similarly, the gear loss rate of the gear mechanism for the first rotor and the gear loss rate of the gear mechanism for the second rotor take substantially identical values. Therefore, instead of calculating the products of the gear loss rates and the torques of the respective rotors and then adding together the absolute values thereof, the absolute values of the torques of the respective rotors may be added together, whereupon the product thereof and the gear loss rate is determined. In other words, the number of multiplications can be reduced, leading to a reduction in the calculation load. According to a third aspect of the present invention, the first rotor and the second rotor may be drive-coupled to an identical output member, and the relative position adjustment mechanism may be constituted as follows. The relative position adjustment mechanism includes, as the gear mechanism, a first differential gear mechanism having three rotary elements and a second differential gear mechanism having three rotary elements. The first differential gear mechanism includes, as the three rotary elements, a first rotor coupled element drive-coupled to the first rotor, a first output coupled element drive-coupled to the output member, and a first fixed element. The second differential gear mechanism includes, as the three rotary elements, a second rotor coupled element drive-coupled to the second rotor, a second output coupled element drive-coupled to the output member, and a second fixed element. One of the first fixed element and the second fixed element is set as a displacing fixed element that moves in conjunction with a drive source for modifying the relative positions of the two rotors, and the other is set as a non-displacing fixed element fixed to a non-rotary member. A gear ratio of the first differential gear mechanism and a gear ratio of the second differential gear mechanism are set such that a rotation speed of the first rotor coupled element and a rotation speed of the second rotor coupled element are identical when the displacing fixed member is in a fixed state.

### BRIEF DESCRIPTION OF THE DRAWINGS

FIG. 1 is a schematic block diagram showing the overall constitution of a control apparatus for a driving apparatus;

FIG. 2 is an axial direction sectional view of the driving apparatus;

FIG. 3 is a skeleton diagram of a relative position adjustment mechanism;

FIGS. 4A, 4B and 4C show a relationship between relative positions of two rotors and a torque;

FIGS. 5A and 5B show a principle diagram and a current-torque characteristic graph relating to a time at which torsion occurs between the rotors;

FIG. 6 is a graph showing an example of a relationship between a torsional torque and the relative positions in a case where a permanent magnet is built into both rotors;

FIG. 7 is a graph showing an example of the relationship between the torsional torque and the relative positions in a case where a permanent magnet is built into one of the rotors;

FIG. 8 is a graph showing an example of a relationship between the relative positions of the two rotors and a system loss; and

FIG. 9 is a graph showing an example of the relationship between the relative positions of the two rotors and the system loss.

### DETAILED DESCRIPTION OF THE EMBODIMENTS

An example of a preferred embodiment of the present invention will be described below on the basis of the drawings. A rotating electrical machine according to the present invention is a variable magnetic flux type rotating electrical machine in which a field flux linked to a stator coil is varied in accordance with circumferential direction relative positions of a first rotor and a second rotor. Accordingly, the rotating electrical machine according to the present invention constitutes a driving apparatus including a rotating electrical machine and a relative position adjustment mechanism that modifies the relative positions of the first rotor and the second rotor. A control apparatus for the driving apparatus according to the present invention performs optimization control on the driving apparatus by controlling the rotating electrical machine and the relative position adjustment mechanism.

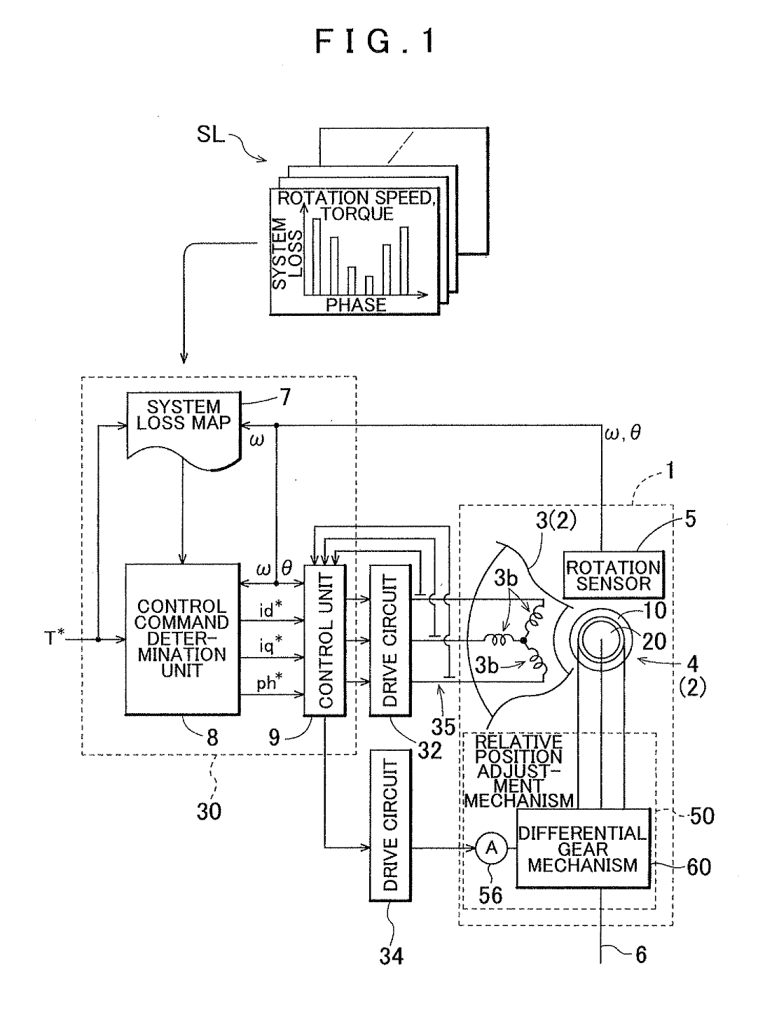

As shown in FIG. 1, a control apparatus 30 includes a system loss map 7, a control command determination unit 8 that determines control commands for a rotating electrical machine 2 and a relative position adjustment mechanism 50, and a control unit 9 that controls the rotating electrical machine 2 and the relative position adjustment mechanism 50 on the basis of the control commands. The system loss map 7 defines a relationship between relative positions at which a system loss is minimized and a required torque (a torque command) T* of a driving apparatus 1 (or the rotating electrical machine 2) and a rotation speed ω of the rotating electrical machine 2. The system loss includes at least electrical loss, including copper loss and iron loss in the rotating electrical machine 2, and mechanical loss in the relative position adjustment mechanism 50. The electrical loss preferably includes inverter loss, which is loss mainly in a switching element of an inverter circuit constituting a part of a drive circuit 32 of the rotating electrical machine 2, in addition to the copper loss and iron loss. The system loss map 7 is generated by collecting loss data SL indicating the relationship between the system loss and the relative positions (phase) at each rotation speed and torque of the rotating electrical machine 2 and obtained through experiments, simulations, and so on, and then subjecting the collected loss data SL to data analysis and data optimization. Note that the system loss may include various types of loss occurring in a driving apparatus other than the examples cited here.

The control command determination unit 8 refers to the system loss map 7 on the basis of the required torque T* and the rotation speed ω to determine a current command id*, iq* for driving the rotating electrical machine 2 and an inter-rotor phase command ph* serving as a control target for the relative positions of two rotors 10, 20, to be described below. In this embodiment, the rotating electrical machine 2 is controlled through universal vector control, and therefore the current command id* is determined in relation to a d axis serving as a direction of magnetic flux from a permanent magnet, and the current command iq* is determined in relation to a q axis that is orthogonal to the d axis in terms of an electrical angle. The inter-rotor phase command ph* denotes a control target of an electrical angle phase difference between (the relative positions of) the two rotors 10, 20. The control unit 9 controls the rotating electrical machine 2 by performing current feedback control on the basis of the current command id*, iq*, a current of a coil 3b of a stator 3 detected by a current sensor 35, and an electrical angle θ of a rotor 4 detected by a rotation sensor 5. Further, the control unit 9 controls the relative position adjustment mechanism 50, or more specifically an actuator (a motor or the like) 56 serving as a drive source that applies driving force to a differential gear mechanism 60, via a drive circuit 34 on the basis of the inter-rotor phase command ph*. Thus, the rotating electrical machine 2 and the relative position adjustment mechanism 50 are controlled on the basis of the determined control commands id*, iq*, ph* such that the system loss is minimized within a range at which the required torque T* can be output. Hence, the control apparatus 30 can perform optimization control on the driving apparatus 1.

[Structure of Rotating Electrical Machine and Driving Apparatus]

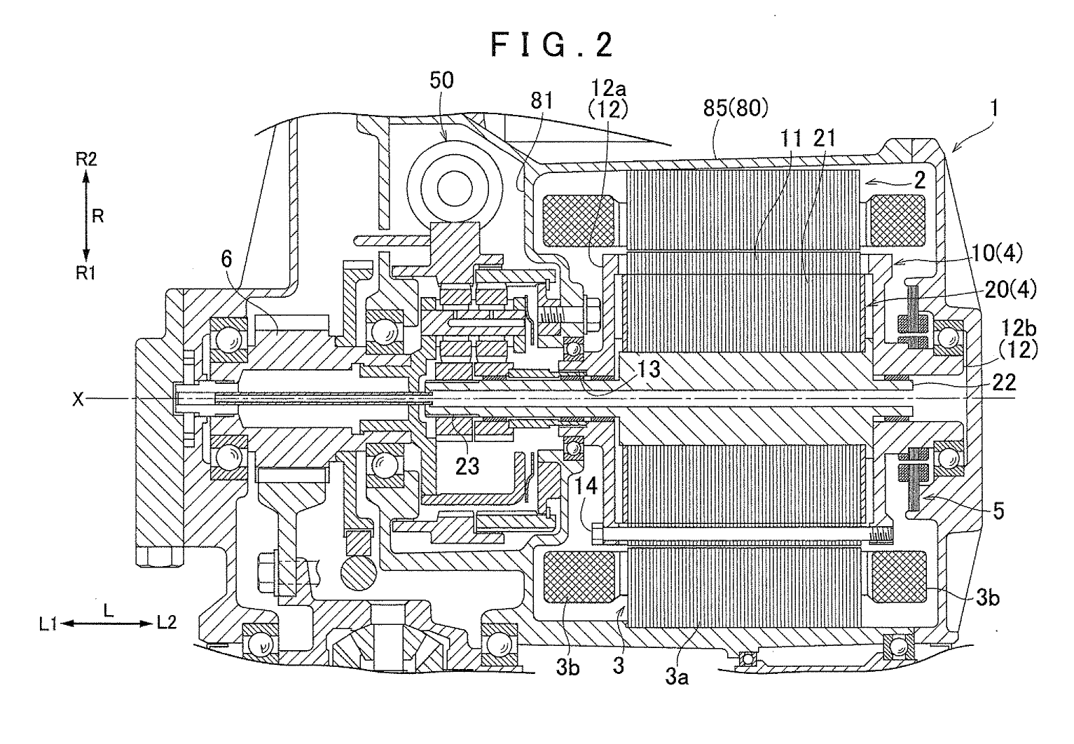

First, a constitutional example of the driving apparatus 1 including the rotating electrical machine 2 and the relative position adjustment mechanism 50 will be described. As shown in FIG. 2, the rotating electrical machine 2 is an inner rotor type rotating electrical machine having two rotors with variable relative positions. The rotor 4 is constituted by the second rotor 10, which is an outer rotor facing the stator 3 and disposed on a relative outer side in this embodiment, and the first rotor 20, which is an inner rotor disposed on a relative inner side. Further, the first rotor 20 includes a first rotor core 21 and a permanent magnet buried in the interior of the first rotor core 21. The second rotor 10 includes a second rotor core 11 and a flux barrier formed in the second rotor core 11. A positional relationship between the permanent magnet and the flux barrier varies according to the relative positions of the first rotor 20 and the second rotor 10, and by varying a magnetic circuit, a field flux is adjusted. The structure of the rotors 10, 20 will be described in detail below.

In the following description, unless noted otherwise, an “axial direction L”, a “radial direction R”, and a “circumferential direction” are defined using an axial center of the coaxially disposed first rotor core 21 and second rotor core 11 (in other words, a rotary axis X) as a reference. Further, in the following description, an “axial first direction L1” indicates a leftward direction in the axial direction L of FIG. 2 while an “axial second direction L2” indicates a rightward direction in the axial direction L of FIG. 2. Furthermore, a “radial inner direction R1” indicates a direction heading toward an inner side (the axial center side) in the radial direction R, while a “radial outer direction R2” indicates a direction heading toward an outer side (the stator side) in the radial direction R.

As shown in FIG. 2, the rotating electrical machine 2 including the stator 3 and the rotor 4 is accommodated in the interior of a case 80. The rotating electrical machine 2 constitutes the driving apparatus 1 together with the relative position adjustment mechanism 50 that adjusts the circumferential direction relative positions of the first rotor 20 and the second rotor 10 so that a driving force (defined as a torque) of the rotating electrical machine 2 can be transmitted to a rotor shaft 6 serving as an output shaft.

The stator 3 is fixed to an inner surface of a peripheral wall portion 85 of the case 80. The stator 3 includes the stator core 3a and a coil (stator coil) 3b wound around the stator core 3a, and constitutes an armature of the rotating electrical machine 2. In this example, the stator core 3a is formed in a cylindrical shape by laminating a plurality of electromagnetic steel plates. The rotor 4, which serves as a field system having a permanent magnet, is disposed on the radial inner direction R1 side of the stator 3. The rotor 4 is supported on the case 80 to be capable of rotating about the rotary axis X, and rotates relative to the stator 3.

The rotor 4 includes the first rotor 20 and the second rotor 10, the circumferential direction relative positions of which can be adjusted. The first rotor 20 includes the first rotor core 21, which is disposed coaxially with the second rotor core 11 on the radial inner direction R1 side, i.e. the opposite side of the second rotor 10 to the stator 3. The first rotor core 21 is disposed to overlap the second rotor core 11 when seen from the radial direction R. In this example, the first rotor core 21 has an identical axial direction L length to the second rotor core 11 and is disposed to overlap the second rotor core 11 completely when seen from the radial direction R. Further, in this example, the first rotor core 21 is formed by laminating a plurality of electromagnetic steel plates. The first rotor 20 includes a first rotor core support member 22 that supports the first rotor core 21 and rotates integrally with the first rotor core 21. The first rotor 20 also includes a permanent magnet that is buried in the interior of the first rotor core 21 in order to provide field flux that is linked to the coil 3b.

The first rotor core support member 22 is formed to support the first rotor core 21 by contacting the first rotor core 21 from the radial inner direction R1 side. Further, the first rotor core support member 22 is supported rotatably relative to a second rotor core support member 12 by a bearing (a bush in this example) disposed on the axial first direction L1 side of the first rotor core 21 and a bearing (a bush in this example) disposed on the axial second direction L2 side of the first rotor core 21. A first spline tooth 23 for creating a spline engagement with a rotary element (a first sun gear 51a in this example) of the relative position adjustment mechanism 50 is formed on an outer peripheral surface of an axial first direction L1 side part of the first rotor core support member 22.

The second rotor 10 includes the second rotor core 11 and is disposed between the stator 3 and the first rotor 20. The second rotor 10 serving as the outer rotor includes the cylindrical second rotor core 11, which is disposed on the radial inner direction R1 side of the stator 3 so as to face the stator 3 in the radial direction R and disposed coaxially with the first rotor core 21. In this example, the second rotor core 11 is also formed by laminating a plurality of electromagnetic steel plates. Further, the second rotor 10 includes the second rotor core support member 12 that supports the second rotor core 11 and rotates integrally with the second rotor core 11.

The second rotor core support member 12 includes a first support portion 12a that supports the second rotor core 11 from the axial first direction L1 side, and a second support portion 12b that supports the second rotor core 11 from the axial second direction L2 side. The first support portion 12a and the second support portion 12b are fastened fixedly in the axial direction L by a fastening bolt 14 inserted into an insertion hole formed in the second rotor core 11. In other words, the second rotor core 11 is held fixedly by being sandwiched between the first support portion 12a and the second support portion 12b.

The first support portion 12a is supported in the radial direction R by a bearing (a roller bearing in this example) disposed on the axial first direction L1 side of the second rotor core 11, while the second support portion 12b is supported in the radial direction R by a bearing (a roller bearing in this example) disposed on the axial second direction L2 side of the second rotor core 11. A second spline tooth 13 for creating a spline engagement with a rotary element (a second sun gear 52a in this example) of the relative position adjustment mechanism 50 is formed on an inner peripheral surface of an axial first direction L1 side part of the first support portion 12a. Further, a sensor rotor of the rotation sensor 5 (a resolver in this example) is attached to an outer peripheral surface of an axial second direction L2 side part of the second support portion 12b so as to rotate integrally therewith. The rotation sensor 5 is used to detect a rotary position (an electrical angle θ) and a rotation speed w of the rotor 4 relative to the stator 3.

Incidentally, the rotating electrical machine 2 according to this embodiment is a variable magnetic flux type rotating electrical machine, and therefore a permanent magnet is provided in at least one of the first rotor core 21 and the second rotor core 11. In this example, a permanent magnet is provided only in the first rotor core 21. Meanwhile, a void serving as a flux barrier is formed in the second rotor core 11. The permanent magnet and the flux barrier are disposed such that field flux reaching the stator 3 varies in accordance with the circumferential direction relative positions of the first rotor 20 and the second rotor 10. For example, the permanent magnet and the flux barrier may be disposed such that both a state in which a magnetic circuit serving as a bypass passage is formed in the second rotor core 11, leading to an increase in an amount of leaked magnetic flux and a reduction in the amount of magnetic flux reaching the stator 3, and a state in which leaked magnetic flux passing through the second rotor core 11 is suppressed, leading to an increase in the amount of magnetic flux reaching the stator 3, can be obtained in accordance with the circumferential direction relative positions of the first rotor 20 and the second rotor 10.

The rotor shaft 6 is an output shaft for outputting the driving force of the driving apparatus 1. The rotor shaft 6 is disposed coaxially with the first rotor core 21 and the second rotor core 11, and is drive-coupled to rotary elements (in this example, a first carrier 51b and a second carrier 52b) of the relative position adjustment mechanism 50, similarly to the first rotor core 21 and second rotor core 11. The first rotor core 21 and the second rotor core 11 rotate at identical rotation speeds (rotor rotation speeds) except during adjustment of the circumferential direction relative positions. In this embodiment, the rotor shaft 6 rotates at a lower rotation speed than the first rotor core 21 and second rotor core 11. In other words, the rotation speed of the rotor shaft 6 is reduced relative to the rotation speed of the rotor 4 in this example such that the torque of the rotating electrical machine 2 is amplified before being transmitted to the rotor shaft 6.

The relative position adjustment mechanism 50 includes, as the differential gear mechanism 60, a first differential gear mechanism 51 having three rotary elements and a second differential gear mechanism 52 having three rotary elements. The relative position adjustment mechanism 50 is disposed on the axial first direction L1 side of the rotating electrical machine 2, while the first differential gear mechanism 51 and the second differential gear mechanism 52 are disposed in series in the axial direction L such that the first differential gear mechanism 51 is positioned on the axial first direction L1 side of the second differential gear mechanism 52. By adjusting the circumferential direction relative positions of the first rotor core support member 22, which is drive-coupled to the first differential gear mechanism 51, and the second rotor core support member 12, which is drive-coupled to the second differential gear mechanism 52, the relative position adjustment mechanism 50 adjusts the circumferential direction relative positions of the first rotor core 21 that rotates integrally with the first rotor core support member 22 and the second rotor core 11 that rotates integrally with the second rotor core support member 12.

In this embodiment, the first differential gear mechanism 51 constituting the differential gear mechanism 60 is constituted by a single pinion type planetary gear mechanism having three rotary elements. More specifically, the first differential gear mechanism 51 includes, as the three rotary elements, the first sun gear 51a drive-coupled to the first rotor 20, the first carrier 51b drive-coupled to the rotor shaft 6, and a first ring gear 51c. Note that the first sun gear 51a and the first ring gear 51c are both rotary elements that mesh with a plurality of pinion gears supported by the first carrier 51b. The first sun gear 51a, the first carrier 51b, and the first ring gear 51c correspond respectively to a “first rotor coupled element”, a “first output coupled element”, and a “first fixed element” according to the present invention.

The first sun gear 51a is drive-coupled to the first rotor core support member 22 so as to rotate integrally therewith (in this example, the first sun gear 51a is spline-engaged to the first rotor core support member 22 by the first spline tooth 23), and thus drive-coupled to the first rotor 20. The first carrier 51b is drive-coupled to the rotor shaft 6 so as to rotate integrally therewith. A rotation position of the first ring gear 51c is adjusted during adjustment of the circumferential direction relative positions of the first rotor 20 and the second rotor 10, and fixed at all other times. In this embodiment, a worm wheel 54 is formed on an outer peripheral surface of the first ring gear 51c. More specifically, the worm wheel 54 is provided integrally with the first ring gear 51c, and the first ring gear 51c rotates integrally and in conjunction with the worm wheel 54 serving as a displacement member. The first ring gear 51c corresponds to a “displacing fixed element” according to the present invention.

The relative position adjustment mechanism 50 includes, in addition to the worm wheel 54, a worm gear 55 engaged to the worm wheel 54 and a motor 56 serving as a drive source (an actuator) for driving the worm gear 55 to rotate. When the worm gear 55 is rotated by a driving force of the motor 56, the worm wheel 54 meshed to the worm gear 55 moves in the circumferential direction, and as a result, the first ring gear 51c rotates. In other words, the motor 56 displaces the worm wheel 54. As shown in FIG. 1, the motor 56 is controlled by the control unit 9 via the drive circuit 34 of the relative position adjustment mechanism 50. Note that a circumferential direction movement amount of the worm wheel 54, or in other words a rotation amount of the first ring gear 51c, is commensurate with a rotation amount of the worm gear 55. The circumferential direction relative positions of the first rotor 20 and the second rotor 10 are determined in accordance with the circumferential direction position of the worm wheel 54. An adjustment range of the circumferential direction relative positions of the first rotor 20 and the second rotor 10 during an operation of the rotating electrical machine 2 is set at an electrical angle range of 90 degrees or 180 degrees, for example. Note that the size of the adjustment range of the circumferential direction relative positions of the first rotor 20 and the second rotor 10 is set in accordance with a circumferential direction length of the worm wheel 54.

In this embodiment, the second differential gear mechanism 52 constituting the differential gear mechanism 60 is also constituted by a single pinion type planetary gear mechanism having three rotary elements. More specifically, the second differential gear mechanism 52 includes, as the three rotary elements, the second sun gear 52a drive-coupled to the second rotor 10, the second carrier 52b drive-coupled to the rotor shaft 6, and a second ring gear 52c. Note that the second sun gear 52a and the second ring gear 52c are both rotary elements that mesh with a plurality of pinion gears supported by the second carrier 52b. The second sun gear 52a, the second carrier 52b, and the second ring gear 52c correspond respectively to a “second rotor coupled element”, a “second output coupled element”, and a “second fixed element” according to the present invention. The second sun gear 52a is drive-coupled to the second rotor core support member 12 so as to rotate integrally therewith (in this example, the second sun gear 52a is spline-engaged to the second rotor core support member 12 by the second spline tooth 13), and thus drive-coupled to the second rotor 10. The second carrier 52b is drive-coupled to the rotor shaft 6 so as to rotate integrally therewith. The second ring gear 52c is fixed to a first wall portion 81 of the case 80, and corresponds to a “non-displacing fixed element” according to the present invention.

In this embodiment, the first carrier 51b and the second carrier 52b are integrated to form an integral carrier 53. In other words, the first carrier 51b serving as the “first output coupled element” and the second carrier 52h serving as the “second output coupled element” are drive-coupled to rotate integrally. Further, the second ring gear 52c is fixed to the case 80. Hence, when the first ring gear 51c is rotated, the first sun gear 51a rotates relative to the second sun gear 52a such that circumferential direction relative positions of the first sun gear 51a and the second sun gear 52a vary. The first rotor core support member 22 is drive-coupled to the first sun gear 51a so as to rotate integrally therewith, and the second rotor core support member 12 is drive-coupled to the second sun gear 52a so as to rotate integrally therewith. Therefore, by adjusting the rotation position of the first ring gear 51c (the circumferential direction position of the worm wheel 54), the circumferential direction relative positions of the first rotor core support member 22 (the first rotor 20) and the second rotor core support member 12 (the second rotor 10) can be adjusted.

Note that a gear ratio of the first differential gear mechanism 51 and a gear ratio of the second differential gear mechanism 52 are set such that in a state where the first ring gear 51c is fixed, the rotation speed of the first sun gear 51a and the rotation speed of the second sun gear 52a are equal. In this embodiment, the first differential gear mechanism 51 and the second differential gear mechanism 52 are formed with identical diameters. Further, a tooth number ratio of the first differential gear mechanism 51 (=the number of teeth of the first sun gear 51a/the number of teeth of the first ring gear 51c) and a tooth number ratio of the second differential gear mechanism 52 (=the number of teeth of the second sun gear 52a/the number of teeth of the second ring gear 52c) are set to be equal. Moreover, as described above, the first carrier 51b and the second carrier 52b are formed integrally, and both the first ring gear 51c and the second ring gear 52c are fixed except during adjustment of the rotation position of the first ring gear 51c. With this constitution, when the first ring gear 51c is fixed, the rotation speed of the first sun gear 51a is equal to the rotation speed of the second sun gear 52a, and therefore the rotation speed of the first rotor core 21 (the first rotor 20) is equal to the rotation speed of the second rotor core 11 (the second rotor 10). Hence, by adjusting the circumferential direction relative positions of the first rotor 20 and the second rotor 10, the rotor 4 constituted by the two rotors 10, 20 rotates integrally while maintaining a rotary phase difference (relative positions and a relative phase) between the two rotors. In other words, the rotor 4 rotates integrally in a state where the relative phase of the two rotors 10, 20 is adjusted.

(Torsional Torque Between the Rotors and System Loss)

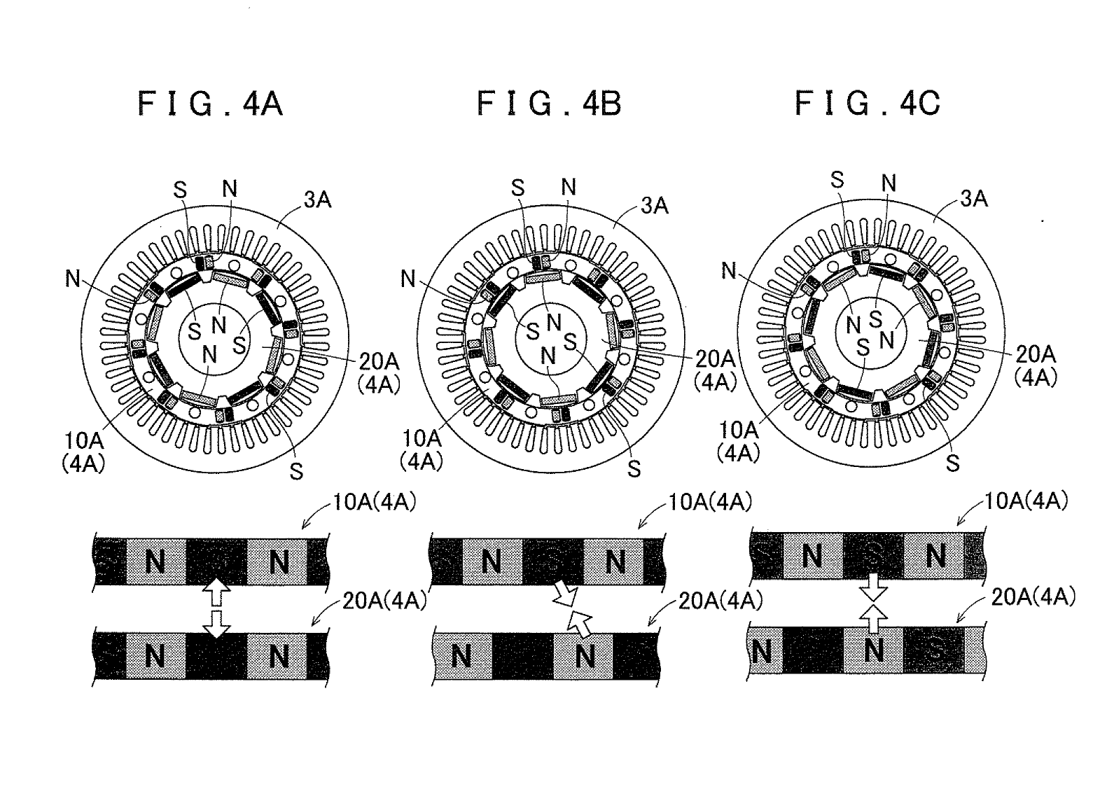

When a mechanism that adjusts the relative positions of two rotors mechanically, such as the relative position adjustment mechanism 50 described above, is provided, mechanical loss is generated by the gear mechanism. A torsional torque corresponding to the relative positions of the two rotors 10, 20 greatly affects the loss generated by the gear mechanism. Generation principles of this torsional torque will be described below with reference to FIGS. 4A, 4B and 4C. To clarify the generation principles of the torsional torque, FIGS. 4A, 4B and 4C show a structure in which a permanent magnet is provided in both rotors rather than in only one rotor as described above. In FIGS. 4A, 4B and 4C, a rotor 4A constituted by an inner rotor 20A (corresponding to the first rotor 20 described above) disposed on the radial direction inner side and an outer rotor 10A (corresponding to the second rotor 10 described above) disposed on the radial direction outer side is disposed on the radial direction inner side of a stator 3A. FIG. 4A shows a state in which the two rotors 10A, 20A are in reference relative positions and the phase is zero degrees in terms of the electrical angle (phase difference zero degrees). FIG. 4B shows a state in which the two rotors 10A, 20A have been shifted by an electrical angle of 90 degrees relative to the reference positions (phase difference 90 degrees). FIG. 4C shows a state in which the two rotors 10A, 20A have been shifted by an electrical angle of 180 degrees relative to the reference positions (phase difference 180 degrees).

When the phase difference is an electrical angle of zero degrees, as shown in FIG. 4A, radially overlapping magnetic poles of the outer rotor 10A and the inner rotor 20A are identical, and therefore a repulsion force is generated between the rotors. This force is oriented in the radial direction of the rotor 4A and therefore has substantially no effect on the torque. Further, when the phase difference is an electrical angle of 180 degrees, as shown in FIG. 4C, the radially overlapping magnetic poles of the outer rotor 10A and the inner rotor 20A are different, and therefore an attraction force is generated between the rotors. This force is also oriented in the radial direction of the rotor 4A and therefore has substantially no effect on the torque. When the phase difference is an electrical angle of 90 degrees, as shown in FIG. 4B, on the other hand, the radially overlapping magnetic poles of the outer rotor 10A and the inner rotor 20A are identical and different alternately. As a result, an attraction/repulsion force is generated between the rotors in a direction that intersects the radial direction, and this attraction/repulsion force is vector-decomposed to a force acting in the rotation direction of the rotor 4A so as to affect the torque. Note that for simplification, FIG. 4B shows only the attraction force.

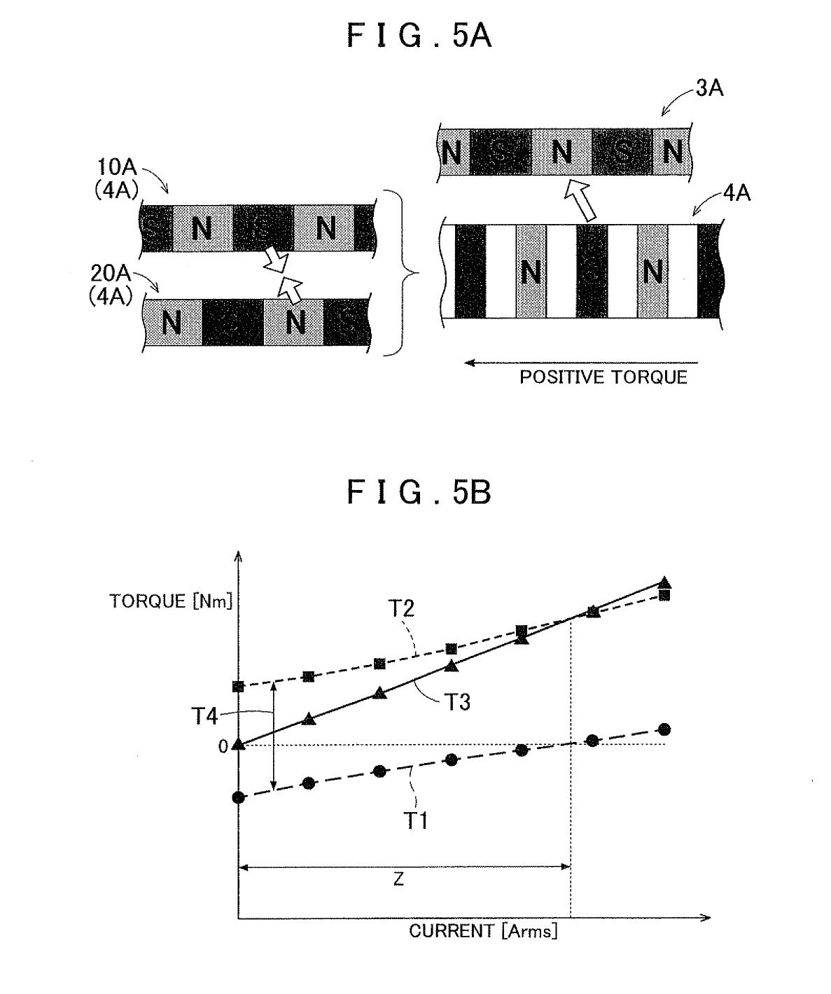

FIGS. 5A and 5B show a total torque in a case where the phase difference is an electrical angle of 90 degrees, as shown in FIG. 4B. FIG. 5A shows in pattern from a torque generated by the permanent magnet of the rotor 4A combining the outer rotor 10A and the inner rotor 20A, which provides field flux to the stator 3A, and a rotating magnetic field of the stator 3A. For convenience, the torque is set to be positive direction torque. A graph in FIG. 5B shows a relationship between a torque T1 generated in the outer rotor 10A, a torque T2 generated in the inner rotor 20A, a total torque T3 serving as the torque generated in the rotor 4A, and a current flowing through a coil of the stator 3A. A torque T4 is a torque resulting from the torque T1 generated in the outer rotor 10A and the attraction/repulsion force generated in the inner rotor 20A. Note that a field angle at this time is 15 degrees.

When the current flowing through the coil of the stator 3A is zero, a rotating magnetic field is not generated in the stator 3A, and therefore the total torque T3 of the rotor 4A is zero. When a rotating magnetic field is generated in the stator 3A by passing a current through the coil such that torque is generated in the rotor 4A in the positive torque direction shown in FIG. 5A, the total torque T3 of the rotor 4A increases as the current increases. The torque generated in the outer rotor 10A may be the torque T4 resulting from attraction to and repulsion from the inner rotor 20A or a torque generated by the rotating magnetic field. As shown in FIGS. 4B and 5A, the torque that acts on the outer rotor 10A in accordance with attraction to and repulsion from the inner rotor 20A is a negative torque oriented in an opposite direction to the positive torque. Hence, in a range Z where the torque generated by the attraction/repulsion force is greater than the torque generated by the rotating magnetic field, the torque acting on the outer rotor 10A is a negative torque. Meanwhile, the torque acting on the inner rotor 20A in accordance with the attraction to and repulsion from the outer rotor 10A is a positive torque.

When the torque of the outer rotor 10A is negative, a sum of the torque of the two rotors 10A, 20A is greater than the total torque of the entire rotor 4. In other words, a sum of absolute values of the torque of the two rotors 10A, 20A is greater than an absolute value of the total torque. Incidentally, when the outer rotor 10A and the inner rotor 20A are respectively joined via a gear mechanism such as the differential gear mechanism 60, as described above, gear loss occurs in the respective gear mechanisms connected to the rotors. When the sum of the absolute values of the torque of the two rotors 10A, 20A increases, a sum total of the gear loss increases correspondingly. In other words, the total gear loss increases as the absolute value of the negative torque acting on the outer rotor 10A increases, leading to an increase in loss torque and a reduction in efficiency.

It is assumed here that respective power transmission mechanisms of the outer rotor 10A and the inner rotor 20A are formed as the first differential gear mechanism 51 and the second differential gear mechanism 52 described above, and that a gear efficiency thereof is 99%, for example. Further, it is assumed that the attraction/repulsion torque T4 between the two rotors is 170 Nm, the torque T1 of the outer rotor 10A is −65 Nm, and the torque T2 of the inner rotor 20A is 105 Nm. In this case, an overall efficiency of the relative position adjustment mechanism 50 combining the two differential gear mechanisms is as follows.

Loss torque of outer rotor 10A: |−65×(1−0.99)|=0.65 [Nm]

Loss torque of inner rotor 20A: |105×(1−0.99)|=1.05 [Nm]

Total loss torque: 0.65+1.05=1.70 [Nm]

Total torque: 105−65=40 [Nm]

Efficiency: ((40−1.7)/40)×100=95.75 [%]

Hence, when a negative torque is generated in one rotor, the sum of the absolute values of the torque output by the outer rotor 10A and the inner rotor 20A must be increased in order to obtain a total torque of an identical magnitude, and therefore the loss torque increases correspondingly. The absolute value of the torque increases steadily as the attraction/repulsion torque T4 increases, and therefore the total loss torque also increases in accordance with the attraction/repulsion torque T4. In other words, as is evident from FIGS. 4A, 4B and 4C, the loss torque included in the mechanical loss differs according to the relative positions between the outer rotor 10A and the inner rotor 20A (the inter-rotor phase difference).

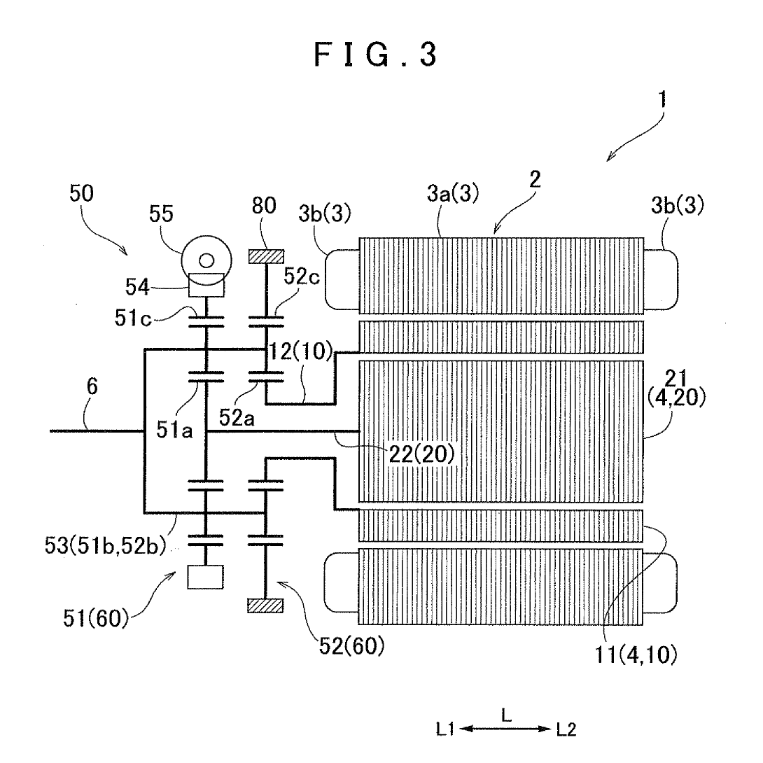

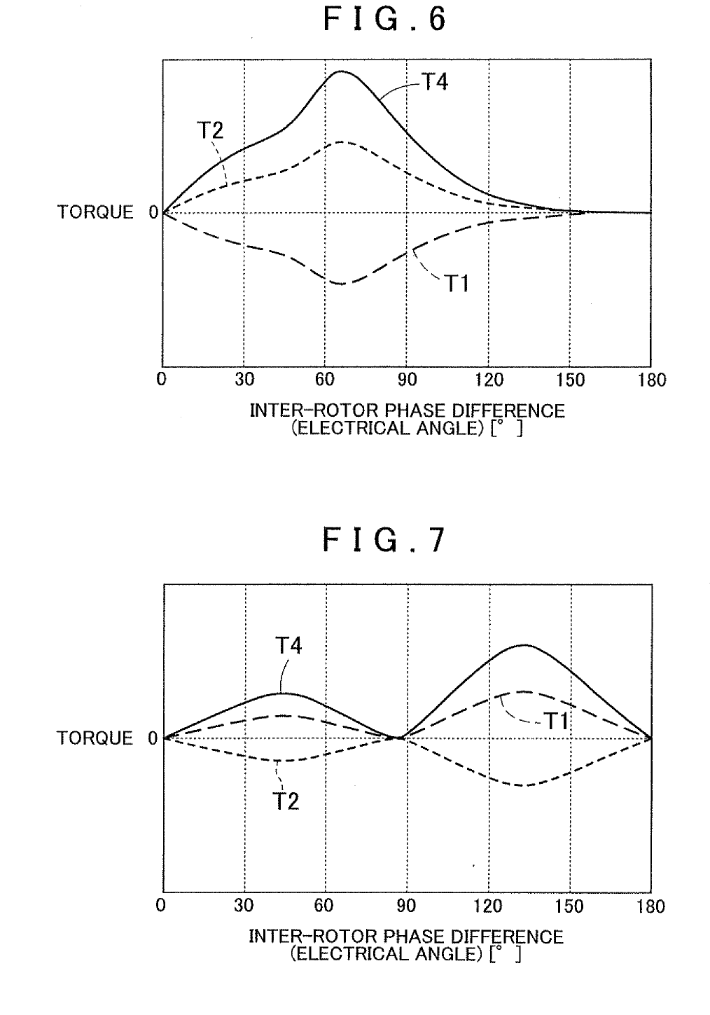

FIGS. 6 and 7 show the torque T1 of the outer rotor 10A corresponding to the inter-rotor phase difference, the torque T2 of the inner rotor 20A, and the inter-rotor attraction/repulsion torque T4. FIG. 6 shows an example of a case in which the outer rotor 10A and the inner rotor 20A both include a permanent magnet, as shown in FIGS. 4 and 5. In this case, the attraction/repulsion torque T4 exhibits a single peak within a relative position (inter-rotor phase difference) range of 180 electrical angle degrees. FIG. 7 shows an example of the case described using FIGS. 2 and 3, in which a permanent magnet is provided only in the first rotor 20 serving as the inner rotor and a void serving as a flux barrier is provided in the second rotor 10 serving as the outer rotor. In this case, no repulsive force exists between the second rotor 10 not having a magnetic pole and the first rotor 20, and therefore, due to the existence of the void, a difference in the attraction force by which the first rotor 20 attracts the second rotor 10 serves as the torque T4 corresponding to the inter-rotor phase difference. Hence, the attraction/repulsion torque (attraction torque in this case) T4 exhibits two peaks within the relative position (inter-rotor phase difference) range of 180 electrical angle degrees.

It is well known that loss such as copper loss, iron loss, and inverter loss affect the efficiency of a rotating electrical machine, and it is therefore desirable to implement control for minimizing this loss. In a variable magnetic flux type rotating electrical machine such as that described above, a field weakening current can be reduced by modifying the field flux mechanically. As a result, copper loss, inverter loss, and iron loss can be suppressed, enabling an improvement in the efficiency of the rotating electrical machine. However, when the relative position adjustment mechanism 50 that mechanically adjusts the relative positions of the two rotors, such as a planetary reduction gear mechanism, is provided, gear loss also occurs, as noted above, and this gear loss differs in accordance with the relative positions of the rotors, as described above using FIGS. 4 to 7. Therefore, when the rotating electrical machine is controlled simply by selecting the relative phase at which copper loss, iron loss, inverter loss, and so on are minimized, it may be impossible to realize optimization control of the entire system, including the relative position adjustment mechanism 50.

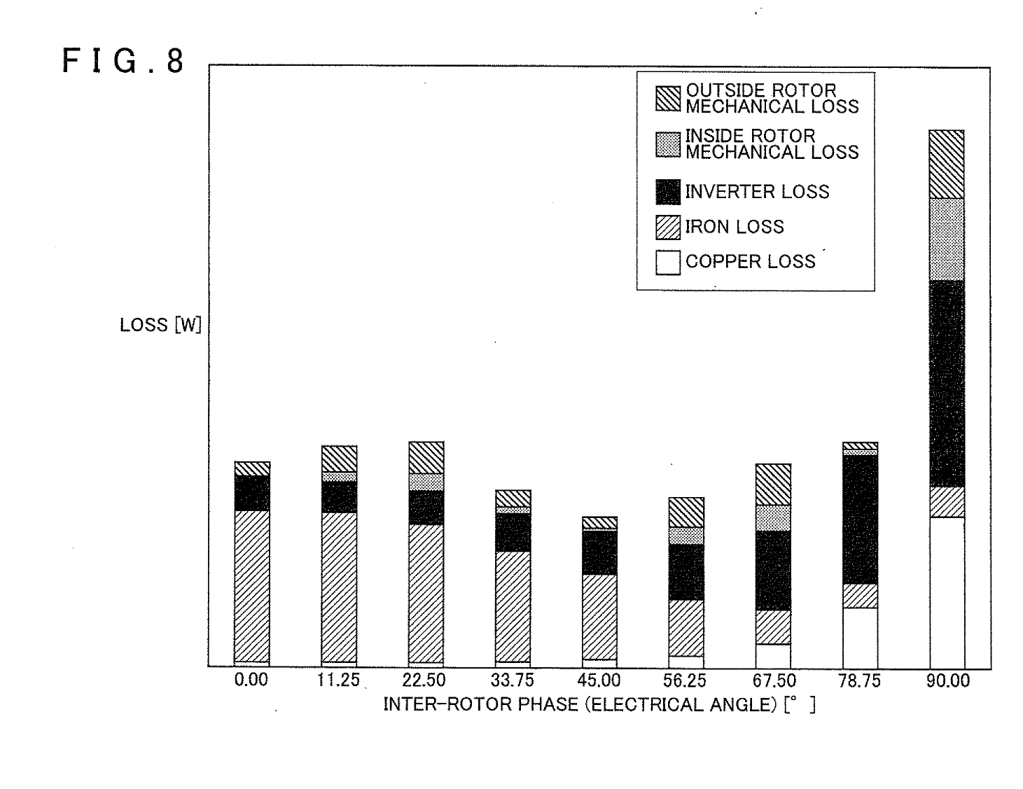

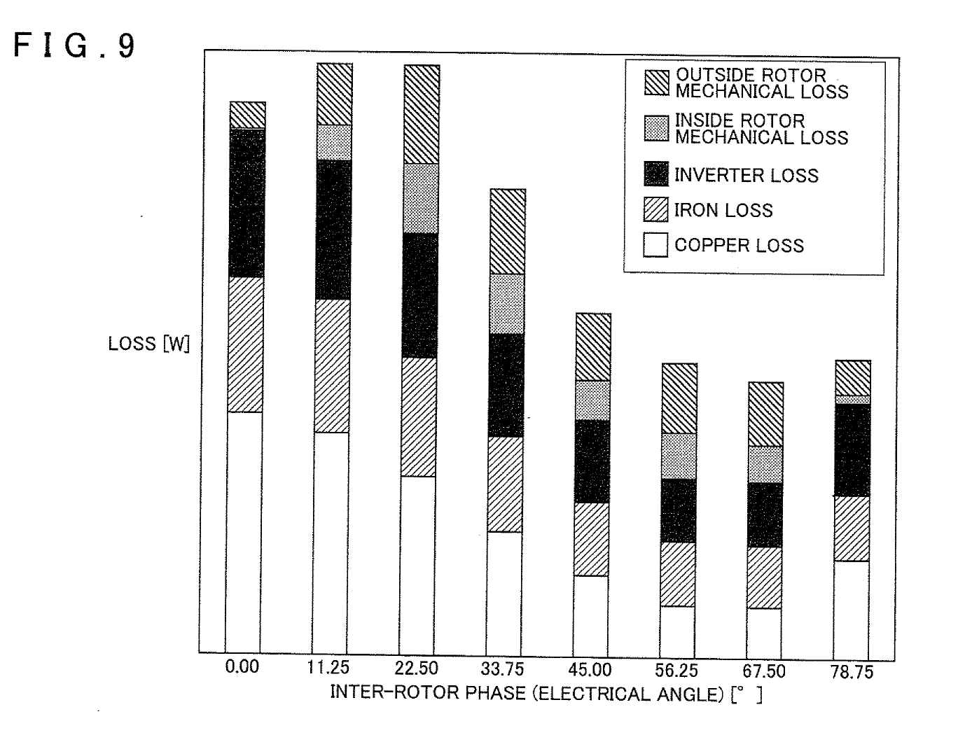

Hence, in this embodiment, optimization control is implemented to minimize system loss including at least electrical loss, which includes copper loss and iron loss in the rotating electrical machine 2, and mechanical loss, which includes gear loss in the relative position adjustment mechanism 50. FIGS. 8 and 9 are graphs showing examples of a relationship between the system loss and the relative positions. Here, iron loss is electric energy such as hysteresis loss and overcurrent loss lost when magnetic flux passing through the stator core 3a and the rotor cores 11, 21 is varied by magnetic fields generated by the coil 3b and the permanent magnet. Copper loss is electric energy lost when turned into Joule heat by resistance in the wire of the coil 3b. Inverter loss is electric energy lost when a switching element constituting the inverter is switched. These loss types are included in electrical loss. As described above, outside rotor mechanical loss and inside rotor mechanical loss are types of mechanical loss represented by gear loss in the relative position adjustment mechanism 50. Note that FIG. 8 shows the system loss at medium speed/medium torque of 4000 rpm, 8 Nm, for example, while FIG. 9 shows the system loss at high speed/high torque of 8000 rpm, 12 Nm, for example.

Referring to FIG. 8, and focusing only on the electrical loss, the loss is minimized when the inter-rotor phase (the relative positions) is 56.25 electrical angle degrees. Hence, when the rotating electrical machine 2 is controlled on the basis of the electrical loss alone, the relative positions are set at this phase. However, the system loss also including the mechanical loss is minimized at an inter-rotor phase of 45 electrical angle degrees. Therefore, to improve the efficiency of the rotating electrical machine 2 (the driving apparatus 1) further, the relative positions are preferably set at 45 degrees on the basis of the system loss. Note that in certain cases, such as an inter-rotor phase of 67.5 degrees shown in FIG. 9, the inter-rotor phase for minimizing the electrical loss is identical to the inter-rotor phase for minimizing the system loss including the mechanical loss.

The electrical loss and the mechanical loss constituting the system loss do not have a correlative relationship enabling easy generalization thereof using a function or the like, and it is therefore preferable to prepare the system loss map 7 as shown in FIG. 1 in order to implement control based on the system loss. As shown in FIGS. 8 and 9, the system loss map 7 is generated on the basis of the loss data SL, which are obtained at each rotation speed and each torque of the rotating electrical machine 2 (the driving apparatus 1) through experiments, magnetic field analysis simulations, and so on.

More specifically, first, the inter-rotor phase and current commands such as a current amplitude and a current phase of the coil 3b are determined on the basis of the required torque and the rotation speed of the rotating electrical machine 2 within the driving range of the driving apparatus 1 and the rotating electrical machine 2. Note that the current commands may also be the current commands id*, iq* relating to the d axis and the q axis of vector control. Next, an experiment or a′simulation is implemented using the rotation speed, the inter-rotor phase, and the current commands as input values. As a result, electrical loss such as iron loss, copper loss, and inverter loss, as shown in FIGS. 8 and 9, and the rotor torque of the first rotor 20 serving as the inside rotor and the second rotor 10 serving as the outside rotor, are obtained as output values.

As described above, an attraction/repulsion torque is generated in the first rotor 20 and the second rotor 10 as a torsional torque, and therefore the loss torque is determined taking this torque into account. In other words, the loss torque is determined on the basis of a sum of an absolute value of a product of the first rotor torque generated in the first rotor 20 in accordance with the relative positions of the two rotors 10, 20 (the inter-rotor phase) and a loss rate of the gear mechanism connected to the first rotor 20 and an absolute value of a product of the second rotor torque generated in the second rotor 10 in accordance with the relative positions of the two rotors 10, 20 and a gear loss rate of the gear mechanism connected to the second rotor 10. Equations and calculation examples are as shown above, using specific numerical values.

Note that during calculation, a product of the loss rate of the gear mechanism and the absolute value of the torque of each rotor 10, 20 may be determined instead of the absolute value of the product of the loss rate of the gear mechanism and the torque of each rotor 10, 20. Needless to mention, this modification is included in the technical scope of the present invention. Further, as long as the gear mechanisms connected to the two rotors 10, 20 are constituted identically and the gear loss rates thereof are equivalent, as is the case with the relative position adjustment mechanism 50 according to this embodiment, a product of the loss rate of the gear mechanism and the sum of the absolute values of the torque of each rotor 10, 20 may be determined rather than determining and adding together the products of the torque of each rotor 10, 20 and the loss rates of the gear mechanisms. By determining a product of the calculated loss torque and the rotation speed ω, a torsion loss, i.e. the mechanical loss, at each rotation speed ω is determined.

By adding together the electrical loss including the iron loss, copper loss, and inverter loss and the mechanical loss including the torsion loss obtained heretofore, the system loss (the loss data SL) shown in FIGS. 8 and 9 is determined. As shown in FIG. 1, the system loss map 7 defining the relationship between the relative positions (inter-rotor phase) at which the system loss is minimized and the required torque T* and rotation speed ω of the rotating electrical machine 2 (the driving apparatus 1) is then generated on the basis of the loss data SL and stored in a non-volatile memory or the like. More specifically, the system loss map 7 is a map defining the relative positions at which the system loss is minimized for each required torque T* and rotation speed ω of the rotating electrical machine 2 (the driving apparatus 1).

As shown in FIG. 1, the control apparatus 30 of the driving apparatus 1 performs optimization control on the driving apparatus 1 (the rotating electrical machine 2) using the system loss map 7. The control command determination unit 8 of the control apparatus 30 refers to the system loss map 7 on the basis of the required torque T* and the rotation speed ω to determine the current command (id*, iq*, for example) for driving the rotating electrical machine 2 and the inter-rotor phase command ph* indicating the relative positions. The control unit 9 then controls the rotating electrical machine 2 on the basis of the current command and a magnetic pole position (rotation angle) θ of the rotor 4, and controls the relative position adjustment mechanism 50 on the basis of the inter-rotor phase command ph*. Note that a map which defines the inter-rotor phase command ph* indicating the relative positions and the current command (id*, iq*, for example) directly on the basis of the required torque T* and the rotation speed ω may be provided instead of the system loss map 7. Further, a plurality of maps may be provided instead of a single map. For example, the inter-rotor phase command ph* may be determined from a map defining optimum relative positions on the basis of the required torque T* and the rotation speed ω, and the current command may be determined from a map defining the current command on the basis of the required torque T*, the rotation speed ω, and the relative positions (the inter-rotor phase command ph*).

### Other Embodiments

(1) In the above embodiment, an example in which a permanent magnet is provided in both the outer rotor and the inner rotor, the circumferential direction relative positions of which can be adjusted, and an example in which a permanent magnet is provided in the inner rotor and a flux barrier is fanned in the outer rotor were used. However, the present invention is not limited thereto, and instead, a permanent magnet may be provided in the outer rotor and a flux barrier may be formed in the inner rotor. Alternatively, permanent magnets may be provided and flux barriers may be formed in both rotors.
(2) Further, in the above embodiment, an inner rotor type rotating electrical machine was described as an example, but the present invention may also be applied to an outer rotor type rotating electrical machine. With respect to other constitutions, the embodiments disclosed in this specification are exemplar in all aspects, and the embodiments of the present invention are not limited thereto. In other words, constitutions obtained by applying appropriate modifications to a part of the embodiments described above are included in the technical scope of the present invention as long as they include the constitutions of the present invention or equivalents thereto and do not depart from the spirit of the invention.

The present invention may be used in a variable magnetic flux type rotating electrical machine capable of adjusting field flux generated by a permanent magnet.

What is claimed is:

1. A control apparatus for a driving apparatus, which controls a driving apparatus that includes a stator, a variable magnetic flux type rotating electrical machine having a first rotor and a second rotor, circumferential direction relative positions of which can be adjusted, and a relative position adjustment mechanism that adjusts the relative positions of the two rotors, comprising:
a control command determination unit that determines, on the basis of a required torque and a rotation speed, an inter-rotor phase command indicating the relative positions for minimizing a system loss including at least an electrical loss, which includes a copper loss and an iron loss of the rotating electrical machine, and a mechanical loss of the relative position adjustment mechanism, and a current command for driving the rotating electrical machine; and
a control unit that controls the rotating electrical machine on the basis of the current command and controls the relative position adjustment mechanism on the basis of the inter-rotor phase command.

2. The control apparatus for a driving apparatus according to claim 1, wherein
the relative position adjustment mechanism includes a gear mechanism that drive-couples the first rotor and the second rotor, and
the mechanical loss of the relative position adjustment mechanism is determined on the basis of a sum of an absolute value of a product of a first rotor torque generated in the first rotor in accordance with the relative positions of the two rotors and a loss rate of the gear mechanism connected to the first rotor and an absolute value of a product of a second rotor torque generated in the second rotor in accordance with the relative positions of the two rotors and a gear loss rate of the gear mechanism connected to the second rotor.

3. The control apparatus for a driving apparatus according to claim 2, wherein
the first rotor and the second rotor are drive-coupled to an identical output member,
the relative position adjustment mechanism includes, as the gear mechanism, a first differential gear mechanism having three rotary elements and a second differential gear mechanism having three rotary elements,
the first differential gear mechanism includes, as the three rotary elements, a first rotor coupled element drive-coupled to the first rotor, a first output coupled element drive-coupled to the output member, and a first fixed element,
the second differential gear mechanism includes, as the three rotary elements, a second rotor coupled element drive-coupled to the second rotor, a second output coupled element drive-coupled to the output member, and a second fixed element,
one of the first fixed element and the second fixed element is set as a displacing fixed element that moves in conjunction with a drive source for modifying the relative positions of the two rotors, and the other is set as a non-displacing fixed element fixed to a non-rotary member, and
a gear ratio of the first differential gear mechanism and a gear ratio of the second differential gear mechanism are set such that a rotation speed of the first rotor coupled element and a rotation speed of the second rotor coupled element are identical when the displacing fixed member is in a fixed state.
